(19) United States
(12) Patent Application Publication
(10) Pub. No.: US 2010/0294318 A1
(43) Pub. Date: Nov. 25, 2010

(54) Apparatus and Method For Cleaning Conveyor Buckets

(76) Inventors: Daryl G. Newsom, Dorton, KY (US); Joey Justice, Dorton, KY (US)

Correspondence Address: JOHN R. BENEFIEL, 525 Lewis Street, BIRMINGHAM, MI, 48009, US

(21) Appl. No.: 12/780,158

(22) Filed: May 14, 2010

Related U.S. Application Data
(60) Provisional application No. 61/216,716, filed on May 20, 2009.

(51) Int. Cl. B08B 9/093

(52) U.S. Cl. 134/22.18; 134/104.2; 134/166 R

(57) ABSTRACT

An apparatus and method for cleaning each bucket of a bucket conveyor in which each successive bucket is brought into a cleaning station on an elevator section of the conveyor where it is tipped sideways and enclosed within an open ended box enclosure and fixed plate engaged by the open end of the box enclosure, the inside of the bucket then cleaned with steam sprays from a steam head carried within the box enclosure, moving side by side during the cleaning. A vacuum collector draws out steam, condensed water and dislodged residue. Additional steam sprays directed from fixed nozzles on the backing plate may optionally be used to clean the bucket exterior bottom and the conveyor chains.

### CROSS REFERENCE TO RELATED APPLICATIONS

This application claims the benefit of U.S. provisional application No. 61/216,716 filed on May 20, 2009

### BACKGROUND OF THE INVENTION This invention concerns bucket conveyors which are used to convey food material during processing or handling.

The buckets are pivotally mounted on recirculating chains so as to be capable of being y caused to tip the bucket and the dump conveyed material in either direction by means of fixed dogs engaging features on the bucket during elevation of the buckets.

A major concern in the food industry is the cleanliness of any surfaces which come into contact with the food material, as any food residue will enable the growth of possibly harmful microorganisms

The buckets previously have typically been cleaned manually with the use of water hoses. brushes, and powerful cleansers which is a slow and labor intensive process, creates messy conditions, and excessive downtime of the processing itself, and may not be thorough enough to insure completely sanitary conditions. The harsh cleansers typically used can be deleterious to the equipment and must be properly used to avoid other problems.

Long time intervals between cleanings may also allow the growth of microorganisms and contamination of the food material.

It is an object of the present invention to provide an apparatus and process for cleaning at least the food contacting surfaces of buckets in a bucket conveyor which is automated, thorough and carried out on a regular basis and does not require complete shutdown of the processing or handling operations in which the bucket conveyor is being used.

### SUMMARY OF THE INVENTION

The above object and other objects of the present invention which will become apparent upon a reading of the following specification and Claims are achieved by a cleaning station along an elevator section of the bucket conveyor which cleaning station may be integrated with the conveyor itself, or temporarily associated therewith.

At the cleaning station, each bucket is tipped and completely received in a horizontally movable open ended box enclosure which engages an aligned fixed backing plate, which mates with the open end of the box enclosure in an advanced position of the box enclosure.

The box enclosure top and bottom walls are slotted to accommodate the conveyor supports and chains in over to allow the box chamber to pass by the conveyor vertical supports and chain drives in moving to the advanced bucket enclosing position.

A steam head is mounted to the box enclosure to project into the enclosure interior through a horizontal slot in the box enclosure end wall, and a slide drive produces back and forth movement of the steam head when the cleaning process is underway to insure complete coverage of super heated steam sprays directed at the interior surfaces of a bucket being cleaned.

Each conveyor bucket is cammed a tipped position with its open top facing sideways and toward the steam head as the bucket moves into the cleaning station such that horizontal motion of the steam head causes it to enter the side facing normally open top of the bucket.

Several nozzles on the steam head direct sprays of superheated (360° F.) steam at all the interior surfaces of the tipped bucket in the box enclosure as the steam head is traversed back arid forth, some of the steam condensing to form water and collecting in the bottom of the box enclosure, from which it is sucked out along with any dirt or other debris by operation of a vacuum collector system connected to an opening in the bottom wall.

Optionally, a manifold on the back plate can be provided with several non-moving spray heads spraying steam at the bucket bottom, and conveyor chains to clean off these non food contacting elements as well.

The box enclosure is then retracted to allow movement of the cleaned bucket out of the station and the next bucket to be cleaned to be tipped and moved into the cleaning station in preparation for cleaning.

### DESCRIPTION OF THE DRAWINGS

FIG. 1 is a diagram of a bucket cleaning apparatus according to the present invention, prior to initiation of a bucket cleaning cycle.

FIG. 2 is a diagram of the apparatus shown in FIG. 1 with the components in an operative position assumed during a bucket cleaning cycle.

FIG. 3 is a pictorial view of a box enclosure and associated components included in the apparatus of FIG. 1, with a bucket to the cleaned shown in a tilted position ready to be cleaned.

FIG. 4 is a pictorial spaced apart view of a bucket conveyor elevator section and a fixed backing plate with a bucket to be cleaned shown in its sideways tilted position enabling cleaning.

FIG. 5 is a pictorial view of a steam cleaning head with a steam feeding tube shown partially broken away.

FIG. 6 is an enlarged sectional view of a fragmentary corner portion of the abutting box enclosure and backing plates shown in FIG. 2.

### DETAILED DESCRIPTION

In the following detailed description, certain specific terminology will he employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to the drawings, the present invention comprises a cleaning station 10 associated with a bucket conveyor elevator section 1 comprised of a series of buckets 12A, 12B, 12C shown being moved vertically by pivoted connections 16 to recirculating chains in slotted conveyor vertical support members 14.

Such bucket conveyors are well known and are widely used in the food industry to handle food material deposited in the buckets 12 during processing, packaging, etc.

Cam pins 18 are typically provided at the outboard locations on each bucket 12 to be engaged with dog elements for tipping the buckets 12 to dump the food stuffs carried in the bucket 12.

In connection with the present invention, each bucket 12 is successively tipped to a sideways orientation as it enters the cleaning station 10 as shown by bucket 12B, as with a dog 13 engaging the left side cam pin 18.

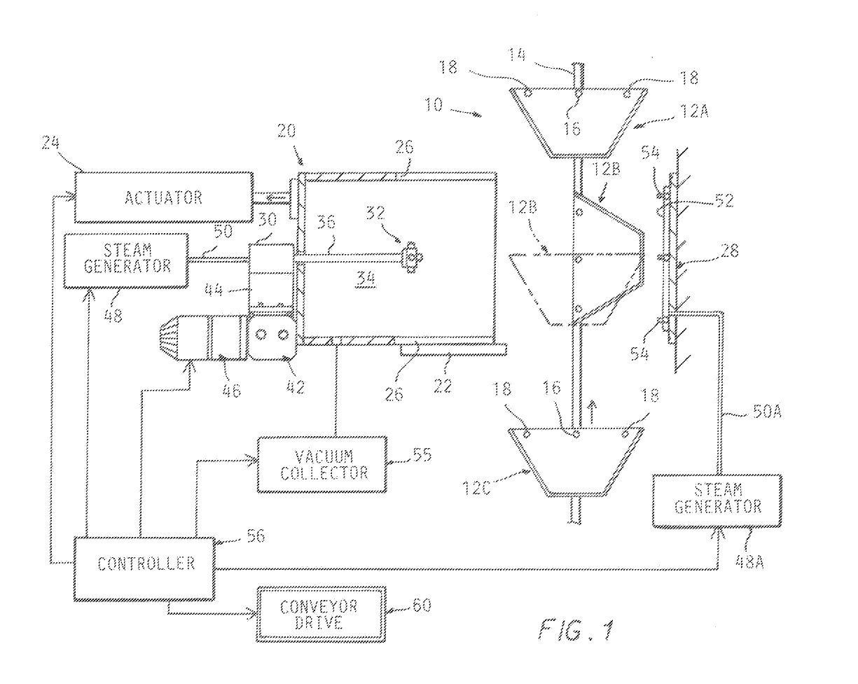

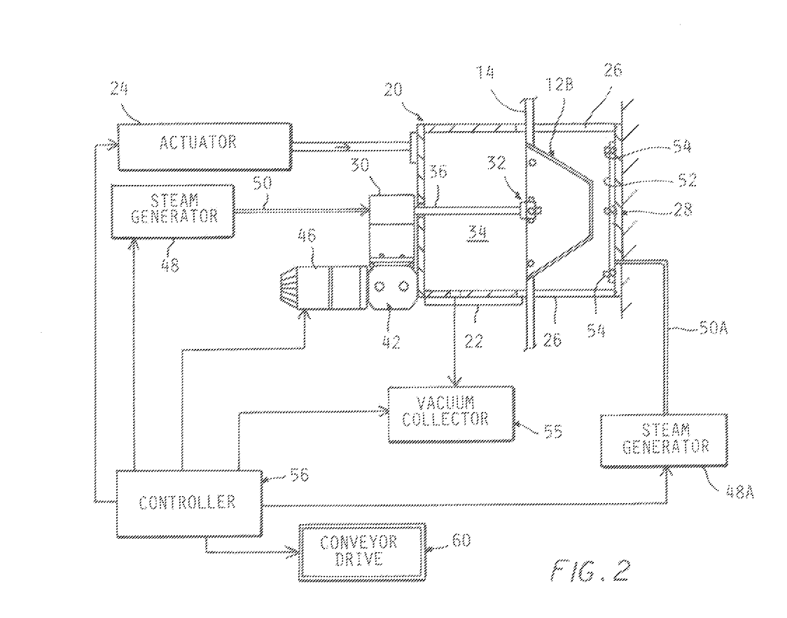

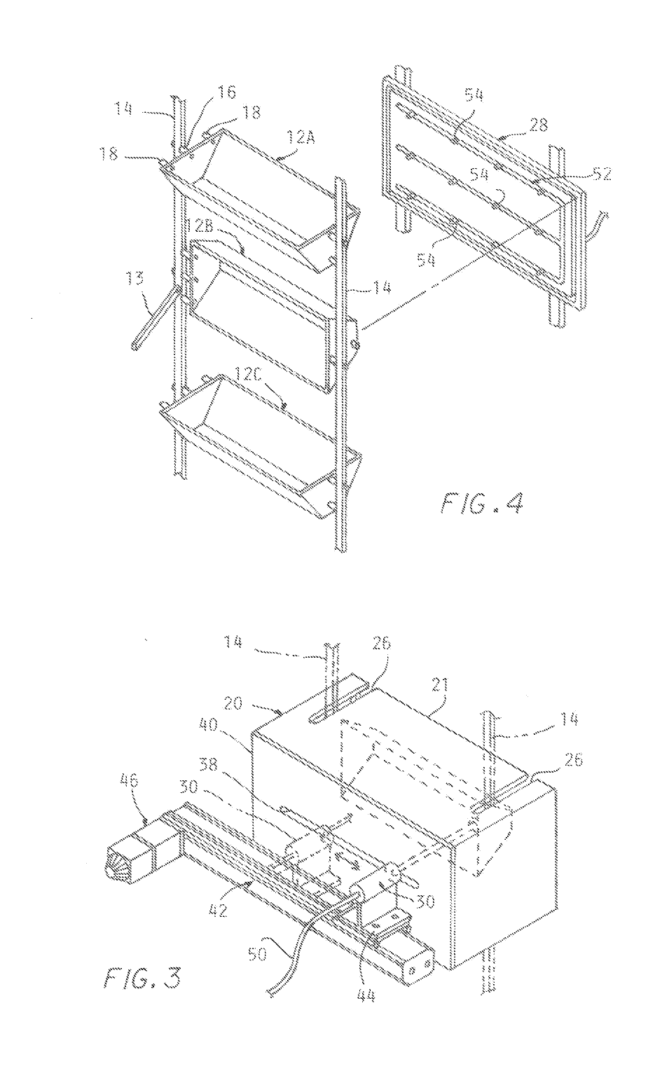

The apparatus includes an open front box enclosure 20 which is slidable on a pair of rails 22 from a retracted position alongside said tipped bucket 12B as shown in FIG. 1 to an extended position received over and enclosing the tipped bucket 12B as shown in FIG. 2, an actuator 24 (such as air cylinders) provided for this purpose, pressurized when a signal is applied to a control valve included in the actuator 24 by the system controller 56.

The box enclosure 20 has top and bottom walls which each have slots 26 formed in either side which are spaced to receive the conveyor support members 14 when the box enclosure 20 is advanced as shown in FIG. 2.

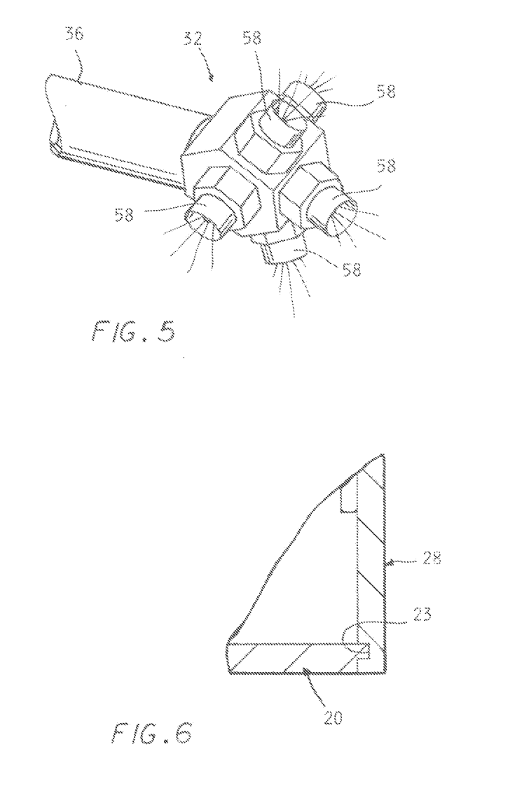

As noted, the tilted bucket 12B is received into the advancing box enclosure 20 and completely enclosed when the open end 21 thereof moves into abutment with a fixed backing plate 28 aligned therewith behind the conveyor elevator section 10 a distance such that abutment occurs as the box enclosure 20 moves to its fully advanced position a slot 23 in the plate 28 may be provided to insure correct alignment therebetween (FIG. 6).

The box enclosure 20 carries a steam head mount 30 from which a vapor tube 36 and steam head 32 projects extending into the interior space 34 of the box enclosure 20, with the vapor tube 36 passing through a horizontal slot 38 in the front wall 40 of box enclosure 20 providing for a purpose to be described.

The steam generator support 30 is mounted on a power slide 42 carrying a steam had mount support base 44. The power slide 42 may include a recirculating timing belt or chain, or a power screw, (not shown) powered by an electric servo motor 46 at one end of the slide 42.

When the servomotor 46 is operated (activated by the system controller 56) the steam head support 30 is caused to traverse back and forth in front of the slot 39 to move the steam head 32 side to side back and forth across the width of the interior of the tipped bucket 12B.

A steam generator 48 is connected as by a high pressure hose 50 to the steam head 32 via the vapor tube 36, the steam generator is of a conventional commercially available type which produces super heated steam (360° F.) to be capable of killing all bacteria and removing all food residues without the use of harmful cleaners.

A steam manifold 52 may also optionally be mounted to the backing plate 28 supplying a series of fixed spray nozzles 54 with steam from a steam generator 48 or from an auxiliary steam generator 48A via hose 50A which can clean the back of the bucket 12B as well as the supports and conveyor chains if desired.

A vacuum collector 55 is connected to the interior space 34 of the box enclosure 20 through a bottom wall opening which collector when activated by a signal from the controller 56 draws out the steam, water condensed for the steam, and any food residue dislodged by the steam spray.

The valving associated with turning steam on and off, operating the vacuum collector, and electrical switching to the servo motor 46 and the actuator 24 as well as the interface with the conveyor drive 60 are under control of the system controller 56 comprised of a suitably programmed industrial controller in the well known manner

The steam head 32 may include an array of five nozzles 58 (FIG. 5) directed at various angles and opposite ends to insure thorough cleaning and sanitizing of all of the interior surfaces of each bucket 12 when combined with the side to side motion thereof.

In operation, as each conveyor bucket 12 enters the cleaning station 10, a tilt dog 13 engages the bucket 12 and tilts it sideways, with an electric eye as other sensor stopping the conveyor drive 56 when the tilted bucket 12 is properly aligned between the box enclosure 20 and fixed backing plate 28.

The actuator 24 is then operated to advance the box enclosure 20 to the right as seen in FIGS. 1 and 2, moving past the bucket 12B until abutting the backing plate 28 and thereby completely enclosing the bucket 12B. The steam generator 48 is then connected to steam head 32 by the opening of a valve (not shown) by a signal from the controller 56, initiating spraying of the interior of the bucket 12 with super heated steam. At the same time, the servo motor 46 is activated so that the steam head 32 moves back and forth across the width of the bucket 12B.

Steam can also he supplied to manifold 52 in a separate cycle to clean the exterior surfaces of the bucket 12 as well as the chains.

The vacuum collector 55 is activated to draw steam, condensed water and removed residue out of the box enclosure 20. After a sufficient interval (which can be variably set to insure complete cleaning) the vacuum collector 55 and steam supply valve are shut off, the servo motor 46 de-energized, the box enclosure 20 retracted, and the conveyor drive 58 restarted to move the next bucket 12C into position for the start of the next cycle, the tipped bucket 12B swinging back down to its normal untipped orientation as it passes by the dog 13.

1. An apparatus for cleaning buckets of a bucket conveyor having an elevator section in which a series of buckets are moved vertically, comprising:
a cleaning station located adjacent said elevator section of said bucket conveyor. said cleaning station including a dog element tipping each successive bucket moved into said station to a sideways facing orientation, said conveyor thereafter stopped by operation of a controller during a cleaning interval;
a box enclosure having one end open and movable by an actuator from a retracted position located alongside said bucket conveyor vertical section where it is clear of said conveyor, to an advanced position receiving said tipped bucket through said open end thereof to enclose said tipped bucket;
a fixed backing plate positioned on an opposite side of said conveyor to be abutted by said open end of said box enclosure when said box enclosure is advanced to substantially completely enclose said tipped bucket;
a steam head connected to said box enclosure and positioned within said tipped bucket when said tipped bucket is received by advance of said box enclosure, said steam head having one or more spray nozzles and connected to a steam generator to direct one or more sprays of steam against the inside of said tipped bucket, whereby said bucket is cleaned thereby.

2. The apparatus according to claim 1 further including a powered slide moving said steam head from side to side while said steam sprays are directed at the inside of said tipped bucket.

3. The apparatus according to claim 1 further including a vacuum collector connected to said box enclosure and activated when said steam sprays are being directed at said inside surfaces of said tipped bucket whereby steam, condensed water and dislodged residue from said tipped bucket are drawn out of said box enclosure.

4. The apparatus according to claim 2 wherein said steam head is carried by said box enclosure on a vapor tube extending into the interior said box enclosure through a slot in a front wall thereof, said powered slide moving said vapor tube side to side in said slot.

5. The apparatus according to claim 1 wherein said box enclosure has a top and bottom side walls formed with aligned pairs of slots located to be aligned with side supports for said elevator section of said bucket conveyor.

6. The apparatus according to claim 1 wherein said box enclosure has a top and bottom side formed with aligned pairs of slots located to be aligned with said supports for said elevator section of said bucket conveyor.

7. The apparatus according to claim 1 wherein said backing plate mounts a manifold connected to a source of steam and having one or more nozzles directing sprays of steam at the bottom of said tipped bucket.

8. The apparatus according to claim 1 wherein said steam head includes a plurality of nozzles including two directed to opposite directions from said steam head and a plurality of other nozzles directed forwardly from said steam head towards said tipped bucket at several different respective angles.

9. A method of cleaning buckets in a bucket conveyor comprising:
successively moving each bucket into a bucket cleaning station on a vertical elevator section of said bucket conveyor while tipping each bucket sideways to orient an interior space in each bucket generally facing sideways, and thereafter stopping said bucket conveyor while holding each bucket in said tipped position;
moving an enclosure over said tipped bucket to enclose the same and directing one or more steam jets at the interior of said tipped bucket to sanitize and clean the same;
moving said bucket out of said enclosure;
restarting said conveyor and releasing said tipped conveyor;
bringing other buckets successively into said cleaning station and repeating said cleaning steps thereon.

10. The method according to claim 9 including enclosing said tipped bucket by advancing an open sided box enclosure from a retracted position on one side of said conveyor to an advanced position over each successive bucket brought into and held tipped in said cleaning station against a fixed plate on an opposite side of said tipped bucket to substantially completely enclose each successive bucket therein.

11. The method according to claim 10 including connecting a steam head to a steam generator and positioning said steam head so as to direct one or more steam sprays at the interior surfaces of each bucket.

12. The method according to claim 11 including moving said steam head side to side while directing said one or more steam sprays at each successive bucket.

13. The method according to claim 12 including mounting said steam head on a vapor tube extending into said box enclosure through a slot formed in an end wall of said box enclosure to accommodate said side to side motion of said steam head.

14. The method according to claim 10 including directing one or more steam sprays at the exterior bottom of each tipped bucket from one or more nozzles mounted to said fixed plate.

15. The method according to claim 9 further including applying a vacuum through a bottom opening in said enclosure to draw out steam, condensed water or dislodged residue therefrom.

16. The method according to claim 10 further including slotting said box enclosure to accommodate vertical supports for said conveyor.
